(19) United States
(12) Patent Application Publication
(10) Pub. No.: US 2022/0072625 A1
(43) Pub. Date: Mar. 10, 2022

(54) MACHINING TOOL WITH ADJUSTABLY FIXED CUTTING INSERT

(71) Applicant: Guehring KG, Albstadt (DE)

(72) Inventor: Klaus Matheis, Sauldorf/Rast (DE)

(73) Assignee: Guehring KG, Albstadt (DE)

(21) Appl. No.: 17/502,080

(22) Filed: Oct. 15, 2021

Related U.S. Application Data
(63) Continuation of application No. PCT/EP2020/060572, filed on Apr. 15, 2020.

(30) Foreign Application Priority Data
Apr. 18, 2019 (DE) 10 2019 205 717.9

(51) Int. Cl. B23B 27/16; B23C 5/24; B23B 27/22

(52) U.S. Cl. CPC B23B 27/1681; B23C 5/2406; B23B 27/143; B23B 27/1607; B23B 27/22; B23C 5/2462

(57) ABSTRACT

A rotatable tool, comprising a tool support body which has an axis and which forms at least one plate seat either directly or in a cartridge in order to receive a cutting plate. By means of a head screw, which passes through the cutting plate, the base of the cutting plate can be pressed against a base support surface, and two plate edges, which form an angle with each other, can be pressed against a respective corresponding edge support surface of the plate seat. Production dimensions are maintained with a low degree of tolerance and the tool is protected from excessive wear to a sufficient degree. Both edge support surfaces are made of support bodies which are movably guided in the tool support body and which can be driven by a corresponding adjustment device in order to finely adjust the cutting plate in a radial and axial direction, respectively.

### TECHNICAL FIELD

The invention relates to a machining tool, in particular a rotatably drivable machining tool, comprising at least one adjustably fixed cutting insert, in particular an adjustably fixed indexable cutting plate, according to the preamble of claim 1.

Machining tools for processing cylindrical workpiece surfaces, in particular rotatably drivable machining tools comprising adjustable cutting inserts, preferably in the design as interchangeable or indexable cutting plate, are widely known. The cutting inserts are thereby received outside of the axis of rotation in a plate seat, which is formed in a cutting insert carrier. The cutting insert is pressed against a base surface of the plate seat by means of a head screw, which passes through said cutting insert, and is simultaneously pressed with its two plate edges, which are at an angle to one another, against a respective corresponding edge support surface. An active cutting edge, which protrudes beyond the plate seat, can thereby be adjusted with regard to its axial or radial position as part of a fine adjustment, in that one of the edge support surfaces is displaced by means of a wedge gear.

In the case of the machining tool according to DE 101 08103A1, the displaceable edge support surface is formed by a wedge surface of an adjusting body, which can be shifted parallel to the base surface. By displacing the adjusting body when the head screw is loosened or tightened, the cutting insert can be finely adjusted either in the axial or radial direction. A similar kinematics is used in the case of a machining tool according to EP 1 447 162 B1.

Machining tools, which are fitted with cutting inserts, are also known, for example from the documents EP 1 044 081 B1, DE 32 36 921 C1, or EP 2 101 944 B1, in the case of which a fine adjustment of the cutting inserts in several directions, thus in the axial and radial direction, is made possible. However, it is not the cutting insert, but a cartridge carrying the cutting insert, which is adjusted in these cases. Such a design can often not be realized for space reasons in the case of complex arrangements of cutting inserts.

A generic tool is known from document EP 2 146 812 B1. The fine adjustment of the cutting plate in the radial direction is accomplished via a highly space-saving design of an adjusting mechanism, in the case of which a sleeve body, which is equipped with a wedge surface, supports a plate edge located radially on the inside. The sleeve body is supported so as to be capable of being shifted in a direction, which runs essentially perpendicular to the base surface of the plate seat, and it has an internal thread, which engages with an adjusting screw. When the head screw is loosened and when the sleeve body is shifted, the cutting plate can be finely adjusted in the radial direction, while it supports itself with a further plate edge, which runs at an angle to the plate edge located on the inside and which generally lies in a perpendicular plane on the tool axis.

In the case of tools, in the case of which the cutting inserts are arranged at a distance not too far from the clamping point, i.e. from the chuck, this type of fine adjustment is sufficient, because the surfaces forming the plate seat can be incorporated into the carrier body with sufficient accuracy, so that an axial fine adjustment can be dispensed with. It has been shown, however, that in the case of machining tools, which are longer and which are constructed in a relatively sophisticated manner, in the case of which several cutting inserts can be used, which are distributed over the circumference and/or in the case of which sets of cutting plates are used, which are staggered axially at an exact distance measure, it becomes difficult to adhere to the required manufacturing accuracies or to protect the cutting plates to a sufficient degree against excessive wear, respectively.

The invention is based on the object of creating a generic machining tool, by means of which narrowly tolerated manufacturing dimensions can be adhered to and the tool can be protected against excessive wear to a sufficient degree even when being fitted with cutting edges in an extremely confined space.

This object is solved by means of a tool comprising the features of claim 1. The special feature of the machining, in particular rotatably drivable tool, is to be seen, among other things, in that each of the two edge support surfaces is formed by a support body, which is movably guided in the tool carrier body, wherein each of the two support bodies can be driven by means of a corresponding adjusting means, in order to provide for a fine adjustment of the cutting plate in the radial and axial direction. It is possible with this design to ensure that, with very small required installation space and with simple hand movements, the tool cutting edges can be positioned optimally even when they are arranged at a larger axial distance from the tool clamping point, in order to effectively counter uneven wear of the tool cutting edges with improved working accuracy of the tool. In an advantageous manner, the new concept utilizes the knowledge that the usually sufficiently large flat support of the cutting plate on the base support surface makes it possible to stabilize the cutting plate during the adjustment in two directions, which are at an angle to one another, such as, e.g., in the radial and axial direction, to such an extent that the required alignment of the cutting edge to the base support surface is still adhered to. Due to the small required installation space for the components of the fine adjustment, the invention lends itself in particular for tools, which require a relatively sophisticated structure of the cutting insert support, which, from an operational aspect, forms the plate seat.

Advantageous designs are subject matter of the subclaims.

The installation space required for the components for the fine adjustment can be further reduced by means of the further development of claim 2. An expanded flexibility in the accommodation of the support bodies and adjusting means in the tool furthermore results with this further development. It is thus possible to optimally integrate the components, which are required for the fine adjustment of the cutting plate, into a specified tool structure.

When the tool is designed according to claim 3, the cutting plate can be finely adjusted particularly exactly. This is so, because the wedge body is received to as to be guided in the wedge-shaped expansion of the plate seat, so that the cutting plate can support itself over a large area on the wedge body continuously, i.e. also when the head screw is loosened or only slightly tightened, respectively. An edge support surface with a smaller area located radially on the inside in the design of an outer wedge surface of a cylindrical sleeve body, which can be moved in a guided manner in a direction, which has a component perpendicular to the base support surface, for example runs essentially perpendicular to the base support surface, is thus sufficient for the radial fine adjustment, whereby additional installation space is saved. With this design, the fine adjustment in the radial direction can furthermore be decoupled from the adjustment in the axial direction, when using cuboid cutting plates. To adjust the cutting plates in a purely radial or purely axial direction, the firm adjustment ratio can be resorted to, which results from the wedge gear and the angle between the plate edges, which support themselves on the edge support surfaces, when using other cutting plate plan shapes.

A particularly stable axial support of the cutting plate results with the further development according to claim 4. The base-side support surface preferably connects to the base support surface via a recess step

The base-side support surface can generally be at any angle to the axial support surface of the wedge body. However, if the base-side support surface is formed parallel to the base support surface for the cutting plate, advantageous manufacturing-related simplifications result. The base-side support surface can be aligned perpendicular to the axial support surface of the wedge body in this case.

In addition to the small space requirement, the design of the further adjusting means according to claim 6 has the further particular advantage that the sensitivity of the fine adjustment can be set solely via the ratio of the thread pitches.

It becomes apparent that it is generally sufficient for a sufficiently stable support of the cutting plate when the edge support surfaces have a line contact with the cutting plate. However, the fine adjustment can be further improved, in particular simplified with regard to the hand movements during the adjustment when the edge support surfaces support the cutting plates in a flat manner, thus for example at the free surfaces of the cutting insert in the case of an indexable cutting plate. Problems with regard to the manufacture of the contact surfaces do not arise thereby, because the cutting plate geometry can clearly define the positioning of the cutting plate surfaces, which are to be supported, and the alignment of the edge support surfaces can be based on the base support surface in a simple manner. The flat support preferably leaves the cutting edges of the cutting plate open.

A particularly simple operation of the adjusting screw with simultaneously simple production of the fine adjustment mimic results with the further development according to claim 8. This design—as well as the design according to claim 9—resorts to the construction according to the applicant's older patent documents EP 2 146 812 B1 and DE 10 2017 212 200 A1, the respective disclosure content of which is hereby expressly included in the present application.

The above-described concept according to the invention of the tool design is generally not limited to a certain geometry of the cutting insert. The cutting plate can in particular essentially have the shape of a straight prism with a triangle, rectangle, or parallelogram as base area, whereby the production of the plate seat is simplified.

The axial forces acting on the cutting plate can be absorbed particularly effectively and carefully by means of the further development of the tool according to claim 11, whereby the cutting plate essentially has the shape of a straight prism with a rectangle or parallelogram as base area.

Exemplary embodiments of the invention will be described in more detail below on the basis of schematic drawings, in which:

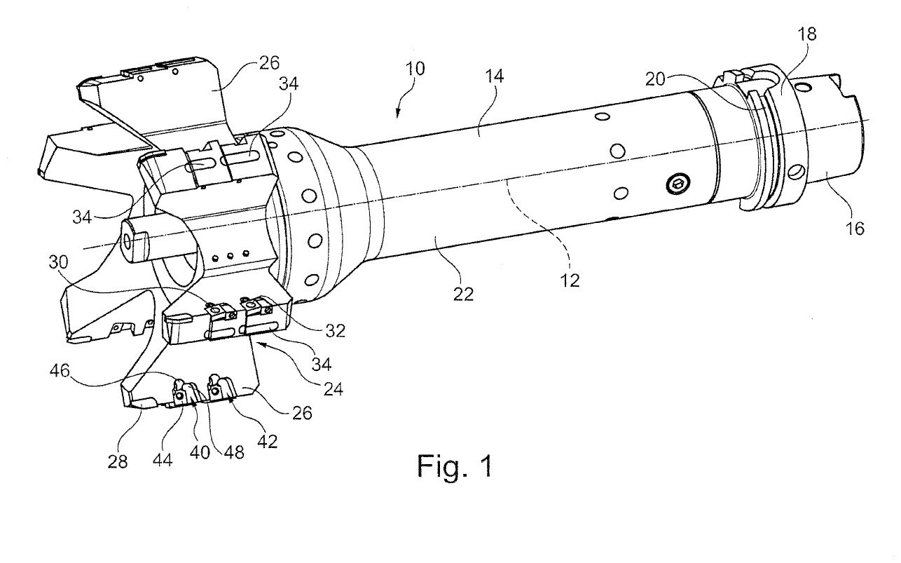

FIG. 1 shows a perspective illustration of a rotatably driven tool, which is fitted with several sets of finely adjustable cutting plates;

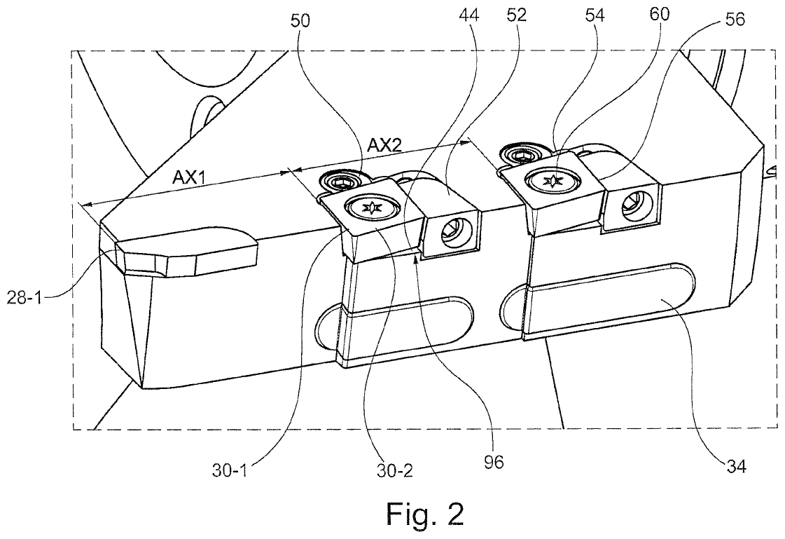

FIG. 2 shows the detail “II” according to FIG. 1;

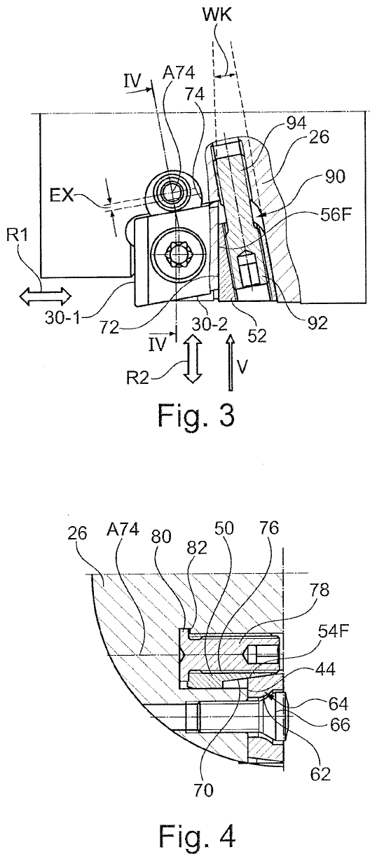

FIG. 3 shows a partially broken-open top view onto a cutting plate with fine adjustment in the axial and radial direction on an enlarged scale;

FIG. 4 shows the sectional view “IV-IV” in FIG. 3;

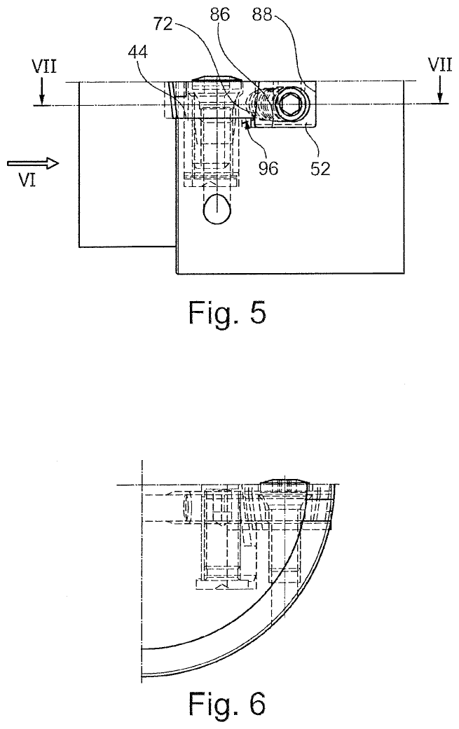

FIG. 5 shows the view “V” according to FIG. 3; and

FIG. 6 shows the view “VI” according to FIG. 5.

### DESCRIPTION OF THE EXEMPLARY EMBODIMENTS

### First Exemplary Embodiment

FIG. 1 shows a machining, rotatably drivable tool, which is identified with reference numeral 10, comprising a tool carrier body 14, which has an axis of rotation 12 and which is driven clockwise. The tool carrier body 14 is designed for the coupling to a non-illustrated spindle comprising HSK interface and therefore has a hollow shaft 16 on the spindle side, to which a carrier shaft 22 connects via a coupling collar 18 comprising a gripper groove 20, which carrier shaft holds the actual cutting edge part 24 comprising a plurality of tool carrier webs 26, which are arranged in a spoke-like or star-like manner, preferably in a releasable and centered manner. Each tool carrier web 26 is fitted with cutting elements 28, 30, 32, of which the cutting bodies 28 are firmly soldered and the cutting bodies 30 and 32 are formed by adjustable cutting inserts. Reference numeral 34 identifies guide strips.

The tool 10 is designed as drilling tool, in particular as boring fine machining tool, wherein the sets of the cutting bodies 28, 30, and 32 in each case process different, axially staggered bore surfaces. To ensure the required working accuracy and service life of the tool, it is important thereby that the cutting bodies 28, 30, 32, which are assembled in a cutting edge group or to form a cutting insert, respectively, are positioned such that the cutting edges 28-1, 28-2, 30-1, 30-2, and 31-1, 32-2, which are in use in each case, of a cutting edge group are positioned on the same cutting circle. It must be ensured at the same time that the front cutting edges 28-1, 30-1, and 32-1 of a respective cutting edge group have the identical axial distance to the coupling collar 18 of the tool. In the event that a stepped bore is processed by means of the tool, it has to lastly be ensured that the axial distance AX1 between the front cutting edges 28-1 and 30-1 and/or AX2 between the front cutting edges 30-1 and 32-1 lies within the permitted tolerance range. This is why the cutting bodies 30, 32, which, in the case of the shown embodiment, are formed by essentially cuboid cutting plates with diamond shape, are thus received in an adjustable manner, preferably in a finely adjustable manner, in so-called plate seats 40, 42, which are incorporated, e.g. milled, into the tool carrier webs 26. In the shown embodiment, the cutting plates 30, 32 are received in the corresponding plate seats 40, 42 in the same way, so that reference will only be made to one plate seat in the following description.

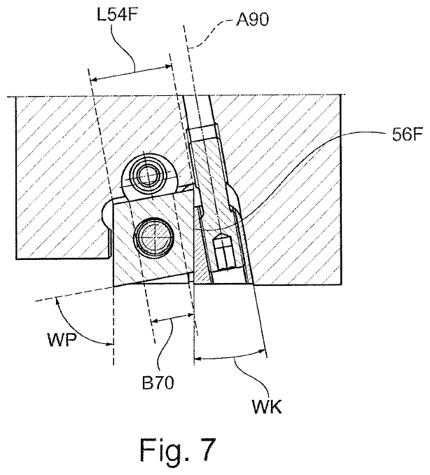

The plate seat in each case forms a base support surface 44 for the support, which is flat, preferably over an area, which is as large as possible, of the cutting plate 30, 32, which is received in the plate seat, and has expansions 46, for receiving support bodies 50, 52, which will be described in detail further below, on which the respective cutting plate 30, 32 supports itself with a plate edge 54, 56, which faces the respective support body 50, 52. The plate edges 54, 56 run at a certain angle WP (see FIG. 7) to one another. A threaded bore 58, into which a head screw 60 can be screwed, which preferably essentially centrically passes through the cutting plate 30, 32, is arranged in the base support surface 44. As can be seen best from FIGS. 3 and 4, the arrangement is thereby made such that the head screw 60 eccentrically passes through a stepped engagement bore 62, which widens over a rounding portion 64, in such a way that when pressing against the base support surface 44 in a flat manner, the screw head, which is identified with 66, presses the cutting plate 30, 32 simultaneously against both support bodies 50 and 52, more precisely against the edge support surfaces 70, 72 thereof.

In the shown exemplary embodiment—as follows from FIGS. 3 and 4—the cutting plate 30 or 32, respectively, rests flat against the assigned edge support surface 70 or 72, respectively. However, a point, multi-point, or line contact would also be possible.

So that the cutting plate 30 or 32, respectively, which, in the shown exemplary embodiment, has the shape of a straight prism with a rectangle or parallelogram as base area and which is arranged in the plate seat 40 or 42, respectively, such that, in the top view perpendicular to the base support surface 44, a plate edge 54 extends perpendicular to the tool axis 12, can be finely adjusted at the tool carrier web 26 in two directions R1 and R2, which are at an angle to one another (see FIG. 3), in the shown exemplary embodiment in the radial and axial direction, both edge support surfaces 70, 72 are formed by support bodies 50, 52, which are movably guided in the tool carrier body 26. For the radial and axial fine adjustment of the cutting plate 30, 32, each of these support bodies 50, 52 can be driven by means of a corresponding adjusting means, which will be described in more detail below.

To begin with, the adjusting means of the support body 50 will be described.

The support body 50 has the shape of a cylindrical sleeve body, which is movably guided in a cylindrical recess 74 by means of the axis A74. The axis A74 stands perpendicularly on the base support surface 44 of the cutting plate 30. The sleeve body 50 has a continuous internal threaded bore 76, which is eccentrically offset to the axis A74 by the measure EX (see FIG. 3 and FIG. 4) and with which an adjusting screw 78 engages, which serves as drive spindle for the sleeve body 50. An adjusting screw head, which is identified with 80, the outer diameter of which is slightly smaller than the inner diameter of the cylindrical recess 74, is caught axially between two stops—as can be seen best from FIG. 4, wherein one of the axial stops is formed by the base of the cylindrical recess 74, and the other axial stop is formed by a shoulder 82 of a bottom-side undercut of the cylindrical recess 74. The adjusting screw 78, which can be inserted through the cylindrical recess 76 all the way to the stop of the adjusting screw head 80, is positionally fixed in this way in the tool carrier body 26 after a small radial shift by the measure EX.

In this position, the cylindrical sleeve body 50 can be attached to the adjusting screw 78, after which the sleeve body 50 can be retracted all the way into the stop position shown in FIG. 4 by rotating the adjusting screw 78 by means of a socket wrench. In this position, an outer wedge surface 70 of the cylindrical sleeve body 50 is aligned parallel to a plate edge surface 54F, which is located radially on the inside, so that, when the cutting plate 30 is assembled, it can ensure the flat radial support of said cutting plate. The outer wedge surface 70, that is the edge support surface radially supporting the cutting plate, is displaced in the radial direction via the drive movement of the adjusting screw 78, whereby a finely adjustable radial stop is provided for the cutting plate 30 or 32, respectively.

The adjusting means for the support body 52 is constructed as follows:

As can be seen best from FIGS. 2 and 5, the edge support surface 72 of the support body 52 is formed by a side surface of a wedge body, which is received in a wedge-shaped expansion 48 of the plate seat 40. The expansion 48 of the plate seat 40 is formed by a base-side support surface 86, which connects to the base support surface 44 via a step 96 and which runs, for example, parallel to the base support surface 44, and by an axial support surface 88, which is at an angle, preferably at a right angle, thereto (see FIG. 5). The wedge body 52 is thus guided parallel to the base support surface 44 by the surfaces 86 and 88, while it abuts with its edge support surface 72, which faces away from the axial support surface 88, preferably in a flat manner, particularly preferably over a large area, against the cutting plate 30, more precisely against the plate edge surface 56F. In the shown exemplary embodiment, the surfaces 72 and 56F abut such that they guide the cutting plate 30 in a plane, which stands perpendicularly on the tool axis 12. The arrangement is furthermore preferably made in such a way that the wedge body 52 does not touch the top-side outer edge of the cutting plate.

It becomes clear from the above description that an axial fine adjustment of the cutting plate 30 is possible by means of moving or shifting, respectively, the wedge body 52 in the direction, which is specified by the surfaces 86, 88, which runs parallel to the axis A90 of the differential threaded screw 90 and thus skewed to the direction of movement A74 of the adjusting body 50. The adjusting means used for this shifting is constructed as follows:

A differential threaded screw 90, which engages with a first threaded portion 92 with the wedge body 52 and which engages with its second threaded portion 94, which is different, including in the opposite direction, with regard to the thread pitch, with the tool carrier body 26, is arranged parallel to the shifting direction, i.e. parallel to the surfaces 86 and 88. Via the drive movement of the differential threaded screw 90, the wedge body 52 can be shifted by means of a socket wrench in order to secure or finely adjust, respectively, the axial position of the cutting plate 30.

It becomes clear from the above description that the directions of movements of the adjusting bodies 50 and 52 are linear, whereby the condition for a simple kinematics is created. The directions of movement furthermore run skewed to one another, with the advantage that more free space remains for the design of the adjusting mechanisms, so that the fine adjustment of the cutting plate is also possible when only a very limited installation space is available.

The process for the fine adjustment of the cutting plates is preferably as follows:

In the positions shown in FIGS. 3 and 4, the cutting plate 30 or 40, respectively, can be inserted into the plate seat 40, 42 by means of loosely assembled adjusting bodies 50, 52. In this position, the head screw 60 can be screwed in so far that the cutting plate rests against the adjusting bodies 50, 52 and is pressed flat against the base support surface 44. The head screw can thereby be tightened either slightly or completely.

In this assembly situation, the axial position (direction R1 in FIG. 3) of the cutting plate 30 or 32, respectively, is initially adjusted in that the differential threaded screw 90 is actuated radially from the outside by attaching a socket wrench. In this phase, the cutting plate supports itself flat on the edge support surface 72 of the wedge body 52. By means of suitable selection of the gear ratio of the gear formed by the differential threaded screw 90 and the wedge angle WK (see FIGS. 3 and 7) between the axial support surface 88 and the edge support surface 72 for the wedge body 52, a sufficiently large adjusting force can be applied to the cutting plate, so that the latter can be adjusted even when the head screw 60 is tightened.

When the adjusting screw 78 is then driven by means of a socket wrench, which can be attached from the cutting plate, in this assembly situation for the radial fine adjustment of the cutting plate 30, 40, so that the sleeve body 50 and thus the outer wedge surface 70 moves out of the receiving opening 74, the cutting plate 30 is pressed to the outside in the radial direction (direction R2 in FIG. 3), while it continuously rests against the edge support surface 72, and thus remains radially guided. It is ensured thereby that the cutting plate 30, 32 does not cant during the fine adjustment even when the width B70, which is shown in FIG. 7, only accounts for a fraction of the length L54F of the plate edge surface 54F.

### FURTHER EXEMPLARY EMBODIMENTS

It goes without saying that modifications of the above-described embodiment are possible, without leaving the basic idea of the invention.

The shape of the cutting plate is not limited to the shape of an essentially straight prism with parallelogram as base area. The cutting plate can also be equipped with the base area of a triangle, rectangle, or of another polygon. Only the fact is crucial that an axial and radial fine adjustment of the cutting plate is possible via the support bodies in such a way that one of the support bodies can guide and stabilize the cutting plate when adjusting the other support plate. A cutting plate, which uses a round cutting plate, which forms secant outer surfaces, can also be used in this respect.

The plate seat 40 or 42, respectively, can also be formed in a cutting edge carrier cartridge.

Instead of the above-described flat support of the cutting plate 30, 32 on the support bodies 50, 52, a point, multi-point, or line-support can also be used.

To optimally utilize the available installation space, the orientation of the axes for the adjustment of the support bodies 50, 52 to one another and with respect to the alignment of the base support surface 44 can also be varied. Lastly, the position of the base support surface can also be changed, e.g., so that the front cutting edge 30-1 of the cutting plate 30 is placed against a plane, which includes the tool axis 12. It is also not required that the front cutting edge 30-1 of the cutting plate 30 lies in a plane, which is perpendicular to the tool axis 12.

The cutting plate 30 can also be formed by an indexable cutting plate, wherein it is required in this case to exclude the cutting edges from a contact with the support bodies 50, 52.

The fine adjustment of the cutting plates can also be used for other tools, for example for milling or broaching tools, or also for non-rotating tools, which are used in lathes.

The adjustment of the support bodies can also take place from a different location, such as, e.g., from the rear side of the tool carrier webs 26.

The stop for the screw head 80 of the adjusting screw 78 can also be provided by an axial securing ring.

The invention thus creates a machining, in particular rotatably drivable tool, comprising a tool carrier body, which has an axis and which forms at least one plate seat for receiving a cutting plate, either in a cartridge or directly. The cutting plate can be pressed with its base against a base support surface by means of a head screw, which passes through said cutting plate, and can simultaneously be pressed with two plate edges, which draw an angle with one another, against a respective corresponding edge support surface of the plate seat. So that narrowly tolerated manufacturing dimensions can also be adhered to when being fitted with cutting edges in an extremely confined space and so as to protect the tool against excessive wear to a sufficient degree, both edge support surfaces are formed by support bodies, which are movably guided in the tool carrier body and which can in each case be driven by means of a corresponding adjusting means for the radial and axial fine adjustment of the cutting plate.

1. A chip-removing tool, comprising a tool carrier body, which has an axis and which forms at least one plate seat for receiving a cutting plate, either in a cartridge or directly, wherein the cutting plate can be pressed with its base against a base support surface by means of a head screw, which passes through said cutting plate, and can simultaneously be pressed with two plate edges, which draw an angle with one another, against a respective corresponding edge support surface of the plate seat, both edge support surfaces formed by support bodies which are movably guided in the tool carrier body and which can in each case be driven by means of a corresponding adjusting element for the radial and axial fine adjustment of the cutting plate.

2. The tool according to claim 1, wherein the support bodies have straight directions of movement, which run skewed to one another.

3. The tool according to claim 2, wherein an edge support surface located radially on the inside is formed by an outer wedge surface of a cylindrical sleeve body, which is supported so as to be capable of being shifted along its axis in a direction that has a component perpendicular to the base support surface, and which has an internal thread, which engages with an adjusting screw, and of which the further edge support surface, which runs at an angle thereto, is aligned in such a way that the cutting plate is finely adjustable in the radial direction when the head screw, is loosened or tightened, while it supports itself on the further edge support surface, which is formed by a side surface of a wedge body, which is received in a wedge-shaped expansion of the plate seat and which can be moved in a guided manner within the wedge-shaped expansion by means of a further adjusting element in such a way that it supports itself on the tool carrier body via two surfaces, which are at an angle to one another.

4. The tool according to claim 3, wherein in the expansion of the plate seat, the wedge body is guided by a base-side support surface and an axial support surface, which is at an angle thereto.

5. The tool according to claim 4, wherein the base-side support surface of the expansion of the plate seat connects via a step to the base support surface for the cutting plate, wherein it is formed parallel to the base support surface for the cutting plate.

6. The tool according to claim 3, wherein the further adjusting element has a differential threaded screw, which engages with a first threaded portion with the wedge body and which engages with its second threaded portion, which is different with regard to the thread pitch, with the tool carrier body.

7. The tool according to claim 1, wherein the edge support surfaces support the cutting plate in a flat manner.

8. The tool according to claim 3, wherein the adjusting screw is positionally fixed in the tool carrier body, in that a screw head is caught axially between two stops.

9. The tool according to claim 8, wherein one of the axial stops is formed by the base of a cylindrical recess for receiving the cylindrical sleeve body, and the other axial stop is formed by a shoulder of an undercut of the cylindrical recess.

10. The tool according to claim 1, wherein the cutting plate essentially has the shape of a straight prism with a triangle, rectangle, or parallelogram as base area.

11. The tool according to claim 10, wherein the cutting plate essentially has the shape of a straight prism with a rectangle or parallelogram as base area, and the cutting plate is arranged in the plate seat, such that, in the top view perpendicular to the base support surface, a plate edge extends in a direction, which has a component perpendicular to the tool axis, which extends perpendicular to the tool axis.

12. The tool according to claim 1, wherein at least one of the edge support surfaces supports the cutting plate in such a way that it does not touch the respective cutting edge, which faces the respective edge support surface.

13. The tool according to claim 2, wherein an edge support surface located radially on the inside is formed by an outer wedge surface of a cylindrical sleeve body, which is supported so as to be capable of being shifted along its axis in a direction that has a component perpendicular to the base support surface, and which has an internal thread, which engages with an adjusting screw, and of which the further edge support surface, which runs at an angle thereto, is aligned in such a way that the cutting plate is finely adjustable in the radial direction when the head screw is loosened or tightened, while it supports itself on the further edge support surface, which is formed by a side surface of a wedge body, which is received in a wedge-shaped expansion of the plate seat and which can be moved in a guided manner within the wedge-shaped expansion by means of a further adjusting element in such a way that it supports itself in a flat manner on the tool carrier body via two surfaces, which are at an angle to one another.

14. The tool according to claim 3, wherein in the expansion of the plate seat, the wedge body is guided by a base-side support surface and an axial support surface, which is at a right angle thereto.
